(19) United States
(12) Patent Application Publication
(10) Pub. No.: US 2010/0042946 A1
(43) Pub. Date: Feb. 18, 2010

(54) SYSTEM AND METHOD FOR WEB-BASED SOFT KEYBOARD CHARACTER ENTRY

(76) Inventors: Marianne L. KODIMER, Huntington Beach, CA (US); Hongfeng (Jason) Wei, Cerritos, CA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 12/435,019

(22) Filed: May 4, 2009

Related U.S. Application Data
(60) Provisional application No. 61/089,081, filed on Aug. 15, 2008.

(51) Int. Cl. G06F 3/048; G06F 15/16

(52) U.S. Cl. 715/773; 709/219

(57) ABSTRACT

The subject application is directed to a system and method for web-based soft keyboard character entry. Web connection sessions with each of a plurality of thin clients is established, wherein each thin client is disposed one of a corresponding plurality of associated workstations via network connection. Keyboard layout data corresponding to each of a plurality of properties of soft keyboard layout is stored in an associated storage. Region data corresponding to a region associated therewith is received from each thin client as well as display size data corresponding to a display size associated therewith. Target-specific keyboard layout data is received for each of the plurality of thin clients in accordance with the keyboard layout data and, region data and display size data associated with each thin client and communicated to each thin client in accordance with the calculation corresponding thereto so as generate a soft keyboard layout thereon.

### CROSS-REFERENCE TO RELATED APPLICATIONS

This application claims priority to U.S. Provisional Patent Application Ser. No. 61/089,081, titled “SYSTEM AND METHOD FOR RECEIVING USER INPUT VIAA TOUCH SCREEN INTERFACE OF AN ASSOCIATED DOCUMENT PROCESSING DEVICE AND CONFIGURING THE TOUCH SCREEN”, filed on Aug. 15, 2008.

### BACKGROUND OF THE INVENTION

The subject application is directed generally to receiving text input via thin client display interfaces. The application is particularly applicable to receipt of text input for operation of document processing devices via a remotely-generated soft keyboard displayed on a web interface.

Early man-machine interface between humans and digital devices was accomplished by entry of text commands via a tangible keyboard. A user would type a command, such as “print,” “delete,” or “run,” followed by an enter key to accomplish the desired machine operation. More recently, graphical user interfaces (GUI), such as graphical displays having indicia selectable by pointing and clicking with a pointing device such as mouse or trackball have become more ubiquitous. Such GUI devices are more intuitive and avoid time-consuming typing, which may also be outside of a human operator's skill set.

The GUI system has been adopted and is in widespread use in connection with web-based sessions, such those that are occur while browsing the world wide web on a browser such as Mozilla, Internet Explorer, Opera, Firefox, or the like.

While GUI based control is often desirable, certain information is still required to be input as text strings, typically entered via a conventional keyboard.

### SUMMARY OF THE INVENTION

In accordance with one embodiment of the subject application, there is provided a system and method for web-based soft keyboard character entry via a web server. Web connection sessions with each of a plurality of thin clients is established, wherein each thin client is disposed one of a corresponding plurality of associated workstations via network connection. Keyboard layout data corresponding to each of a plurality of properties of soft keyboard layout is stored in an associated storage. Region data corresponding to a region associated therewith is received from each of the thin clients as well as display size data corresponding to a display size associated therewith. Target-specific keyboard layout data is received for each of the plurality of thin clients in accordance with the keyboard layout data and, region data and display size data associated with each of the thin clients and communicated to each thin client in accordance with the calculation corresponding thereto so as generate a soft keyboard layout thereon.

Still other advantages, aspects and features of the subject application will become readily apparent to those skilled in the art from the following description wherein there is shown and described a preferred embodiment of the subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of a system for web-based soft keyboard character entry according to one embodiment of the subject application;

FIG. 2 is a block diagram illustrating device hardware for use in the system for web-based soft keyboard character entry according to one embodiment of the subject application;

FIG. 3 is a functional diagram illustrating the device for use in the system for web-based soft keyboard character entry according to one embodiment of the subject application;

FIG. 4 is a block diagram illustrating controller hardware for use in the system for web-based soft keyboard character entry according to one embodiment of the subject application;

FIG. 5 is a functional diagram illustrating the controller for use in the system for web-based soft keyboard character entry according to one embodiment of the subject application;

FIG. 6 is a functional diagram illustrating a server for use in the system for web-based soft keyboard character entry according to one embodiment of the subject application;

FIG. 7 is a functional diagram illustrating a workstation for use in the system for web-based soft keyboard character entry according to one embodiment of the subject application;

FIG. 8 is a block diagram illustrating the system for web-based soft keyboard character entry according to one embodiment of the subject application;

FIG. 9 is a functional diagram illustrating the system for web-based soft keyboard character entry according to one embodiment of the subject application;

FIG. 10 is a flowchart illustrating a method for web-based soft keyboard character entry according to one embodiment of the subject application;

FIG. 11 is a flowchart illustrating a method for web-based soft keyboard character entry according to one embodiment of the subject application; and

FIG. 12 is an example illustration of a soft keyboard for use in the system and method for web-based soft keyboard character entry according to one embodiment of the subject application.

### DETAILED DESCRIPTION OF THE PREFERRED EMBODIMENT

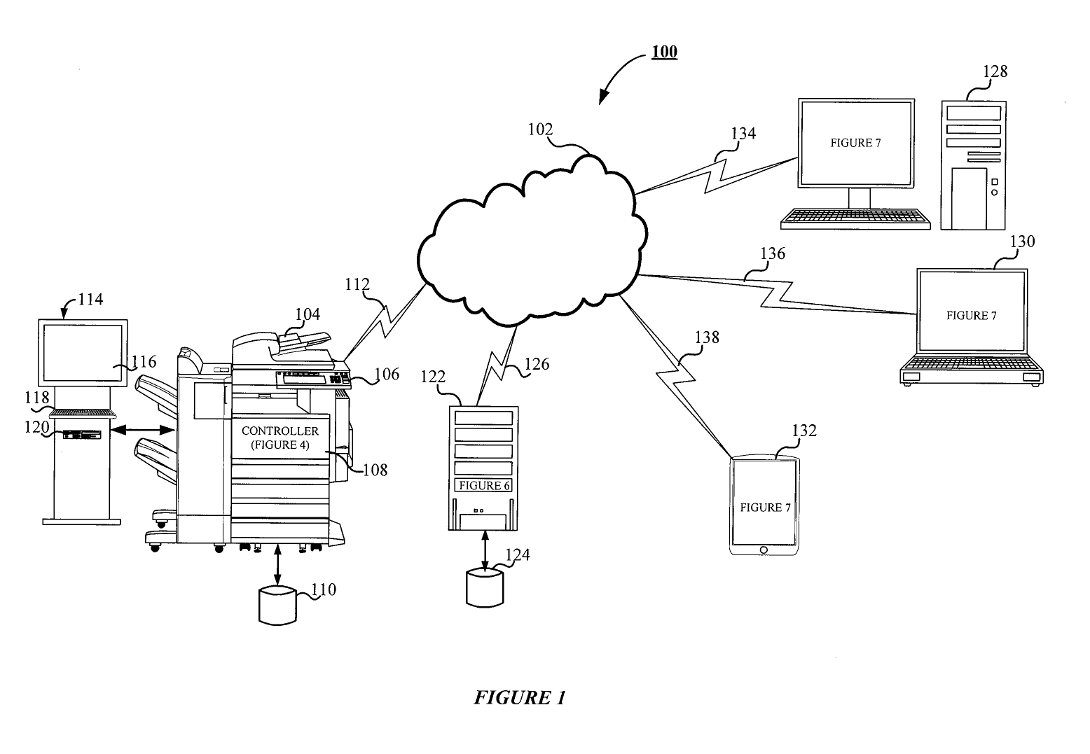

The subject application is directed to a system and method for receiving text input via a thin client display interface. In particular, the subject application is directed to a system and method for web-based soft keyboard character entry via a web server. More particularly, the subject application is directed to a system and method that is applicable to receipt of text input for operation of document processing devices via a remotely-generated soft keyboard displayed on a web interface. It will become apparent to those skilled in the art that the system and method described herein are suitably adapted to a plurality of varying electronic fields employing graphical user interfaces, including, for example and without limitation, communications, general computing, data processing, document processing, or the like. The preferred embodiment, as depicted in FIG. 1, illustrates a document processing field for example purposes only and is not a limitation of the subject application solely to such a field.

Referring now to FIG. 1, there is shown an overall diagram of a system 100 for web-based soft keyboard character entry in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or the any suitable combination thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms. The skilled artisan will appreciate that while a computer network 102 is shown in FIG. 1, the subject application is equally capable of use in a stand-alone system, as will be known in the art.

The system 100 also includes a document processing device 104, which is depicted in FIG. 1 as a multifunction peripheral device, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document processing devices include, for example and without limitation, the Toshiba e-Studio Series Controller. In accordance with one aspect of the subject application, the document processing device 104 is suitably adapted to provide remote document processing services to external or network devices. Preferably, the document processing device 104 includes hardware, software, and any suitable combination thereof, configured to interact with an associated user, a networked device, or the like.

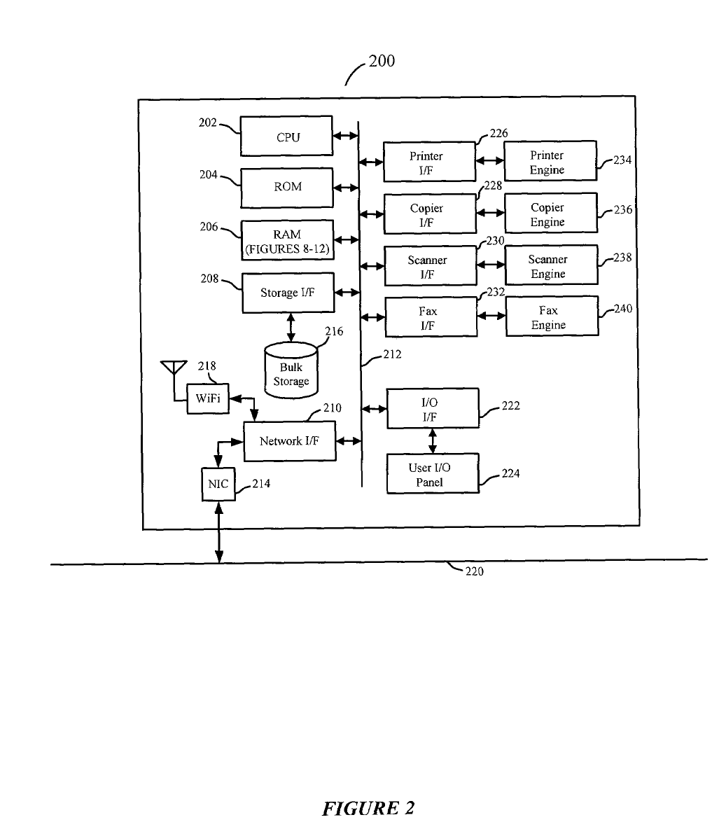

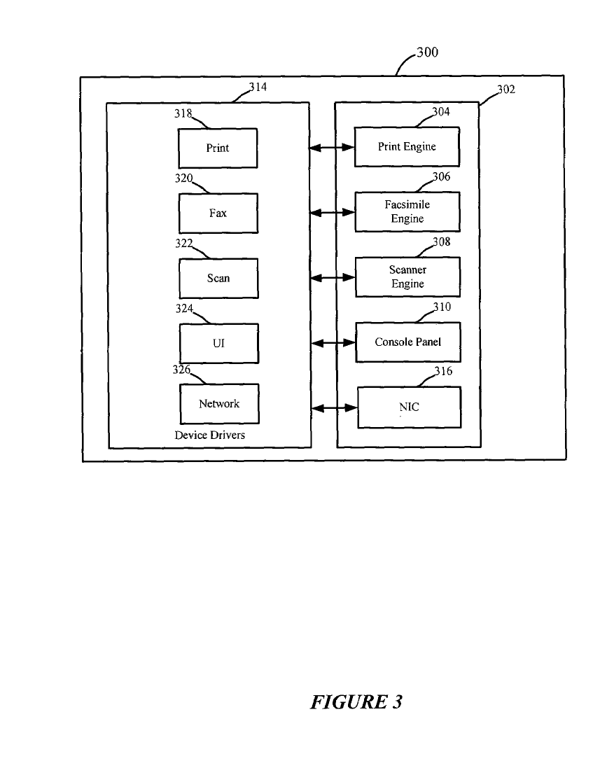

According to one embodiment of the subject application, the document processing device 104 is suitably equipped to receive a plurality of portable storage media, including, without limitation, Firewire drive, USB drive, SD, MMC, XD, Compact Flash, Memory Stick, and the like. In the preferred embodiment of the subject application, the document processing device 104 further includes an associated user interface 106, such as a touchscreen, LCD display, touch-panel, alpha-numeric keypad, or the like, via which an associated user is able to interact directly with the document processing device 104. In accordance with the preferred embodiment of the subject application, the user interface 106 is advantageously used to communicate information to the associated user and receive selections from the associated user. The skilled artisan will appreciate that the user interface 106 comprises various components, suitably adapted to present data to the associated user, as are known in the art. In accordance with one embodiment of the subject application, the user interface 106 comprises a display, suitably adapted to display one or more graphical elements, text data, images, thin client interfaces, or the like, to an associated user, receive input from the associated user, and communicate the same to a backend component, such as the controller 108, as explained in greater detail below. Preferably, the document processing device 104 is communicatively coupled to the computer network 102 via a communications link 112. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art. The functioning of the document processing device 104 will be better understood in conjunction with the block diagrams illustrated in FIGS. 2 and 3, explained in greater detail below.

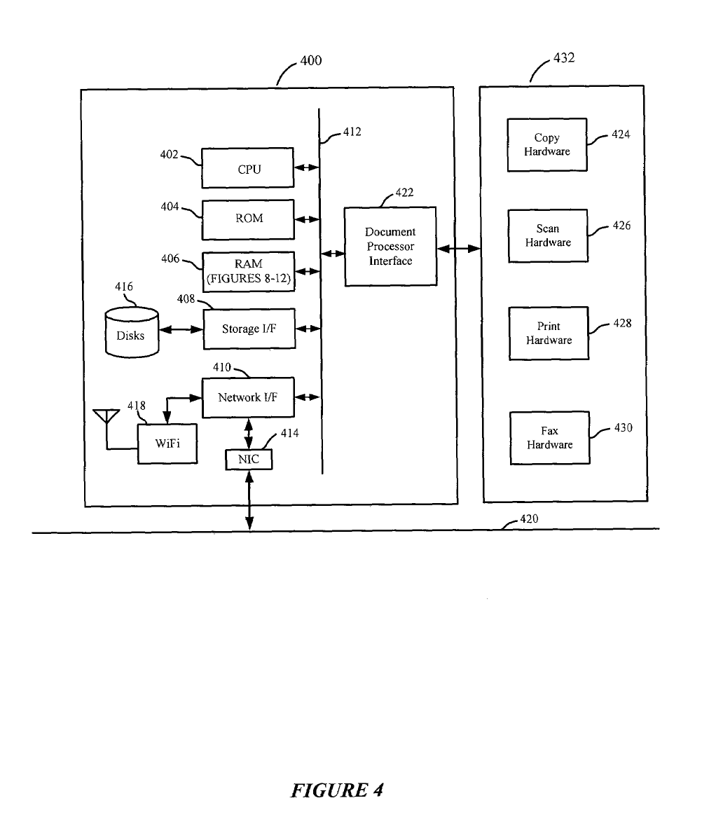

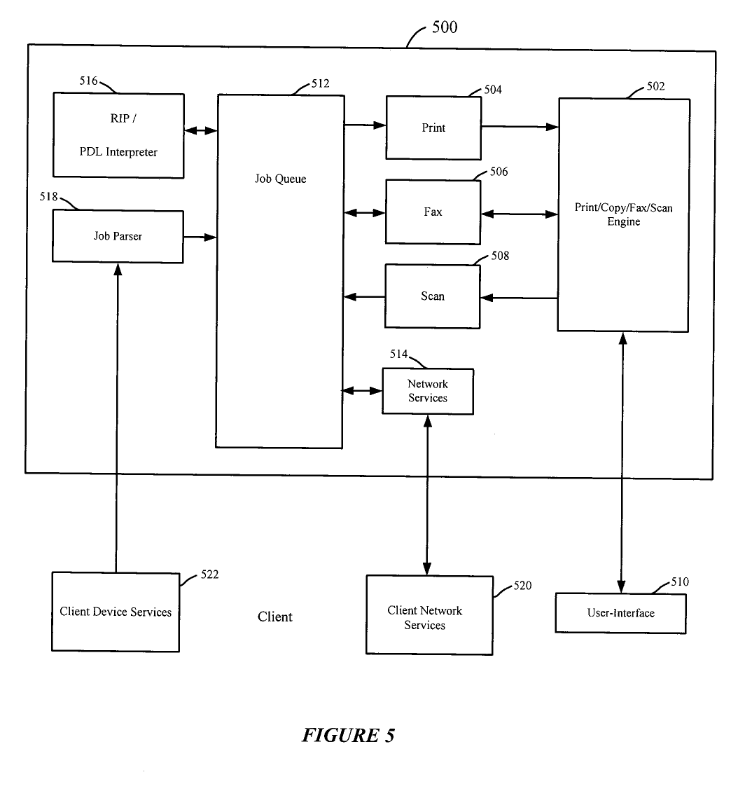

In accordance with one embodiment of the subject application, the document processing device 104 incorporates a backend component, designated as the controller 108, and suitably adapted to facilitate the operations of the document processing device 104, as will be understood by those skilled in the art. Preferably, the controller 108 is embodied as hardware, software, or any suitable combination thereof, configured to control the operations of the associated document processing device 104, facilitate the display of images via the user interface 106, direct the manipulation of electronic image data, and the like. For purposes of explanation, the controller 108 is used to refer to any myriad of components associated with the document processing device 104, including hardware, software, or combinations thereof, functioning to perform, cause to be performed, control, or otherwise direct the methodologies described hereinafter. It will be understood by those skilled in the art that the methodologies described with respect to the controller 108 is capable of being performed by any general purpose computing system, known in the art, and thus the controller 108 is representative of such general computing devices and is intended as such when used hereinafter. Furthermore, the use of the controller 108 hereinafter is for the example embodiment only, and other embodiments, which will be apparent to one skilled in the art, are capable of employing the web-based soft keyboard character entry system and method of the subject application. The functioning of the controller 108 will better be understood in conjunction with the block diagrams illustrated in FIGS. 4 and 5, explained in greater detail below.

Communicatively coupled to the document processing device 104 is a data storage device 110. In accordance with the one embodiment of the subject application, the data storage device 110 is any mass storage device known in the art including, for example and without limitation, magnetic storage drives, a hard disk drive, optical storage devices, flash memory devices, or any suitable combination thereof. In one embodiment, the data storage device 110 is suitably adapted to store scanned image data, character set data, user-supplied data fields, modified image data, redacted data, user information, cellular telephone data, document processing instructions, graphical user interface data, customer information, workflow data, payment data, document data, image data, electronic database data, or the like. It will be appreciated by those skilled in the art that while illustrated in FIG. 1 as being a separate component of the system 100, the data storage device 110 is capable of being implemented as an internal storage component of the document processing device 104, a component of the controller 108, or the like, such as, for example and without limitation, an internal hard disk drive, or the like.

FIG. 1 also illustrates a kiosk 114 communicatively coupled to the document processing device 104, and in effect, the computer network 102. It will be appreciated by those skilled in the art that the kiosk 114 is capable of being implemented as a separate component of the document processing device 104, or as an integral component thereof. Use of the kiosk 114 in FIG. 1 is for example purposes only, and the skilled artisan will appreciate that the subject application is capable of implementation without the use of the kiosk 114. In accordance with one embodiment of the subject application, the kiosk 114 includes an associated display 116, and a user input device 118. As will be understood by those skilled in the art the kiosk 114 is capable of implementing a combination user input device/display, such as a touchscreen interface. According to one embodiment of the subject application, the kiosk 114 is suitably adapted to display prompts to an associated user, receive document processing instructions from the associated user, display a thin client interface, receive payment data, receive selection data from the associated user, and the like. Preferably, the kiosk 114 includes a magnetic card reader, conventional bar code reader, or the like, suitably adapted to receive and read payment data from a credit card, coupon, debit card, or the like.

The system 100 of FIG. 1 also includes a portable storage device reader 120, coupled to the kiosk 114, which is suitably adapted to receive and access a myriad of different portable storage devices. Examples of such portable storage devices include, for example and without limitation, flash-based memory such as SD, xD, Memory Stick, compact flash, CD-ROM, DVD-ROM, USB flash drives, or other magnetic or optical storage devices, as will be known in the art.

The system 100 illustrated in FIG. 1 further depicts a backend component, shown as the server 122, in data communication with the computer network 102 via a communications link 126. It will be appreciated by those skilled in the art that the server 158 is shown in FIG. 1 as a component of the system 100 for example purposes only, and the subject application is capable of implementation without the use of a separate backend server component, e.g. the server 158 is capable of implementation via the document processing device 104, or via one of a plurality of client devices 128, 130, and 132 (discussed in greater detail below). The skilled artisan will appreciate that the server 122 comprises hardware, software, and combinations thereof suitably adapted to provide one or more services, web-based applications, communication with thin client interfaces, storage options, and the like, to networked devices. In accordance with one example embodiment of the subject application, the server 122 includes various components, implemented as hardware, software, or a combination thereof, for managing retention of secured documents, text data, performing searches, comparisons, maintaining database entries, account information, receiving payment data, retrieval of documents, and the like, which are accessed via the computer network 102.

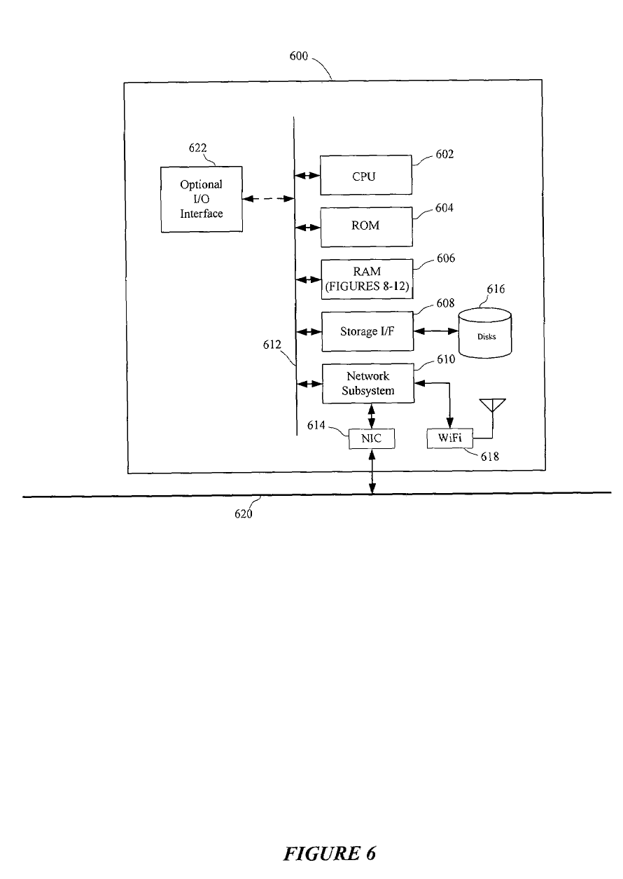

The communications link 126 is any suitable data communications means known in the art including, but not limited to wireless communications comprising, for example and without limitation Bluetooth, WiMax, 802.11a, 802.11b, 802.11g, 802.11(x), a proprietary communications network, infrared, the public switched telephone network, optical, or any suitable wireless data transmission system, or wired communications known in the art. It will further be appreciated by those skilled in the art that the components described with respect to the server 122 are capable of implementation on any suitable computing device coupled to the computer network 102, e.g. the controller 108, or the like. The functioning of the server 122 will better be understood in conjunction with the block diagram illustrated in FIG. 6, explained in greater detail below.

Communicatively coupled to the server 122 is the data storage device 124. According to the foregoing example embodiment, the data storage device 124 is any mass storage device, or plurality of such devices, known in the art including, for example and without limitation, magnetic storage drives, a hard disk drive, optical storage devices, flash memory devices, or any suitable combination thereof. In such an embodiment, the data storage device 124 is suitably adapted to store account information, document processing device identification data, client device identification data, regional data, thin client interface data, keyboard layout data, keyboard property data, HTML keyboard data, JavaScript keyboard data, update software, policy information, and the like. It will be appreciated by those skilled in the art that while illustrated in FIG. 1 as being a separate component of the system 100, the data storage device 124 is capable of being implemented as an internal storage component of the server 122, or the like, such as, for example and without limitation, an internal hard disk drive, or the like.

Also depicted in FIG. 1 are a plurality of client devices, illustrated as a workstation 128, a laptop computer 130, and a portably communications device 132. Each client device 128-132 is preferably in data communication with the computer network 102 via corresponding communications links 134, 136, and 138. It will be appreciated by those skilled in the art that the client devices 128, 130, and 132 are shown in FIG. 1 as a workstation computer, a laptop computer, and a portable communications device for illustration purposes only. As will be understood by those skilled in the art, the client devices 128, 130, and 132 are representative of any personal computing device known in the art including, for example and without limitation, a laptop computer, a personal computer, a personal data assistant, a web-enabled cellular telephone, a smart phone, a proprietary network device, or other web-enabled electronic device. According to one embodiment of the subject application, the client devices 128, 130, and 132 further include software, hardware, or a suitable combination thereof configured to interact with the document processing device 104, communicate with the server 122, or the like. Preferably, each client device 128, 130, and 132 includes a suitable thin client interface, such as a web browser.

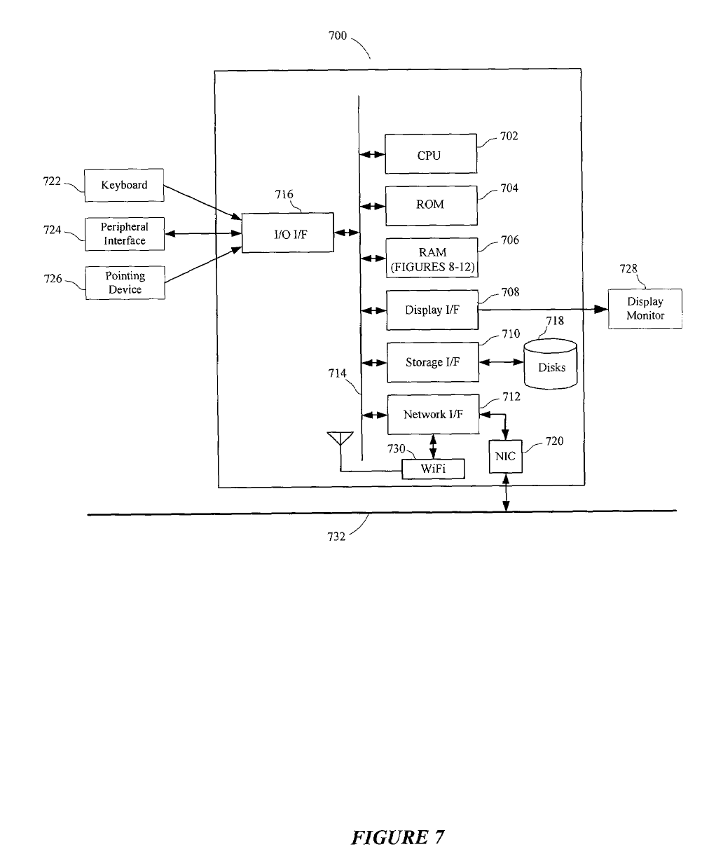

The communications links 134, 136, and 138 are any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. Preferably, the client devices 128, 130, and 132 are suitably adapted to provide document data, job data, user interface data, image data, monitor document processing jobs, employ thin-client interfaces, generate display data, generate output data, or the like, with respect to the document processing device 104, or any other similar device coupled to the computer network 102. According to one embodiment of the subject application, each client device 128, 130, and 132 are capable of implementing a soft keyboard via an associated touch screen interface. The functioning of the client devices 128, 130, and 132 will better be understood in conjunction with the block diagram illustrated in FIG. 7, explained in greater detail below.

Turning now to FIG. 2, illustrated is a representative architecture of a suitable device 200, shown in FIG. 1 as the document processing device 104, on which operations of the subject system are completed. Included is a processor 202, suitably comprised of a central processor unit. However, it will be appreciated that the processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the device 200.

Also included in the device 200 is random access memory 206, suitably formed of dynamic random access memory, static random access memory, or any other suitable, addressable memory system. Random access memory provides a storage area for data instructions associated with applications and data handling accomplished by the processor 202.

A storage interface 208 suitably provides a mechanism for volatile, bulk or long term storage of data associated with the device 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the device 200 to communicate to other devices. The network interface subsystem 210 suitably interfaces with one or more connections with external devices to the device 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface card 214 is interconnected for data interchange via a physical network 220, suitably comprised of a local area network, wide area network, or a combination thereof.

Data communication between the processor 202, read only memory 204, random access memory 206, storage interface 208 and the network subsystem 210 is suitably accomplished via a bus data transfer mechanism, such as illustrated by the bus 212.

Suitable executable instructions on the device 200 facilitate communication with a plurality of external devices, such as workstations, document rendering devices, other servers, or the like. While, in operation, a typical device operates autonomously, it is to be appreciated that direct control by a local user is sometimes desirable, and is suitably accomplished via an optional input/output interface 222 to a user input/output panel 224 as will be appreciated by one of ordinary skill in the art.

Also in data communication with the bus 212 are interfaces to one or more document processing engines. In the illustrated embodiment, printer interface 226, copier interface 228, scanner interface 230, and facsimile interface 232 facilitate communication with printer engine 234, copier engine 236, scanner engine 238, and facsimile engine 240, respectively. It is to be appreciated that the device 200 suitably accomplishes one or more document processing functions. Systems accomplishing more than one document processing operation are commonly referred to as multifunction peripherals or multifunction devices.

Turning now to FIG. 3, illustrated is a suitable document processing device, depicted in FIG. 1 as the document processing device 104, for use in connection with the disclosed system. FIG. 3 illustrates suitable functionality of the hardware of FIG. 2 in connection with software and operating system functionality as will be appreciated by one of ordinary skill in the art. The document rendering device 300 suitably includes an engine 302 which facilitates one or more document processing operations.

The document processing engine 302 suitably includes a print engine 304, facsimile engine 306, scanner engine 308 and console panel 310. The print engine 304 allows for output of physical documents representative of an electronic document communicated to the processing device 300. The facsimile engine 306 suitably communicates to or from external facsimile devices via a device, such as a fax modem.

The scanner engine 308 suitably functions to receive hard copy documents and in turn image data corresponding thereto. A suitable user interface, such as the console panel 310, suitably allows for input of instructions and display of information to an associated user. It will be appreciated that the scanner engine 308 is suitably used in connection with input of tangible documents into electronic form in bitmapped, vector, or page description language format, and is also suitably configured for optical character recognition. Tangible document scanning also suitably functions to facilitate facsimile output thereof.

In the illustration of FIG. 3, the document processing engine also comprises an interface 316 with a network via driver 326, suitably comprised of a network interface card. It will be appreciated that a network thoroughly accomplishes that interchange via any suitable physical and non-physical layer, such as wired, wireless, or optical data communication.

The document processing engine 302 is suitably in data communication with one or more device drivers 314, which device drivers allow for data interchange from the document processing engine 302 to one or more physical devices to accomplish the actual document processing operations. Such document processing operations include one or more of printing via driver 318, facsimile communication via driver 320, scanning via driver 322 and a user interface functions via driver 324. It will be appreciated that these various devices are integrated with one or more corresponding engines associated with the document processing engine 302. It is to be appreciated that any set or subset of document processing operations are contemplated herein. Document processors which include a plurality of available document processing options are referred to as multi-function peripherals.

Turning now to FIG. 4, illustrated is a representative architecture of a suitable backend component, i.e., the controller 400, shown in FIG. 1 as the controller 108, on which operations of the subject system 100 are completed. The skilled artisan will understand that the controller 400 is representative of any general computing device, known in the art, capable of facilitating the methodologies described herein. Included is a processor 402, suitably comprised of a central processor unit. However, it will be appreciated that processor 402 may advantageously be composed of multiple processors working in concert with one another as will be appreciated by one of ordinary skill in the art. Also included is a non-volatile or read only memory 404 which is advantageously used for static or fixed data or instructions, such as BIOS functions, system functions, system configuration data, and other routines or data used for operation of the controller 400.

Also included in the controller 400 is random access memory 406, suitably formed of dynamic random access memory, static random access memory, or any other suitable, addressable and writable memory system. Random access memory provides a storage area for data instructions associated with applications and data handling accomplished by processor 402.

A storage interface 408 suitably provides a mechanism for non-volatile, bulk or long term storage of data associated with the controller 400. The storage interface 408 suitably uses bulk storage, such as any suitable addressable or serial storage, such as a disk, optical, tape drive and the like as shown as 416, as well as any suitable storage medium as will be appreciated by one of ordinary skill in the art.

A network interface subsystem 410 suitably routes input and output from an associated network allowing the controller 400 to communicate to other devices. The network interface subsystem 410 suitably interfaces with one or more connections with external devices to the device 400. By way of example, illustrated is at least one network interface card 414 for data communication with fixed or wired networks, such as Ethernet, token ring, and the like, and a wireless interface 418, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 414 is interconnected for data interchange via a physical network 420, suitably comprised of a local area network, wide area network, or a combination thereof.

Data communication between the processor 402, read only memory 404, random access memory 406, storage interface 408 and the network interface subsystem 410 is suitably accomplished via a bus data transfer mechanism, such as illustrated by bus 412.

Also in data communication with the bus 412 is a document processor interface 422. The document processor interface 422 suitably provides connection with hardware 432 to perform one or more document processing operations. Such operations include copying accomplished via copy hardware 424, scanning accomplished via scan hardware 426, printing accomplished via print hardware 428, and facsimile communication accomplished via facsimile hardware 430. It is to be appreciated that the controller 400 suitably operates any or all of the aforementioned document processing operations. Systems accomplishing more than one document processing operation are commonly referred to as multifunction peripherals or multifunction devices.

Functionality of the subject system 100 is accomplished on a suitable document rendering lo device, such as the document processing device 104, which includes the controller 400 of FIG. 4, (shown in FIG. 1 as the controller 108) as an intelligent subsystem associated with a document rendering device. In the illustration of FIG. 5, controller function 500 in the preferred embodiment, includes a document processing engine 502. A suitable controller functionality is that incorporated into the Toshiba e-Studio system in the preferred embodiment. FIG. 5 illustrates suitable functionality of the hardware of FIG. 4 in connection with software and operating system functionality as will be appreciated by one of ordinary skill in the art.

In the preferred embodiment, the engine 502 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document rendering devices that perform one or more of the document processing operations listed above.

The engine 502 is suitably interfaced to a user interface panel 510, which panel allows for a user or administrator to access functionality controlled by the engine 502. Access is suitably enabled via an interface local to the controller, or remotely via a remote thin or thick client.

The engine 502 is in data communication with the print function 504, facsimile function 506, and scan function 508. These functions facilitate the actual operation of printing, facsimile transmission and reception, and document scanning for use in securing document images for copying or generating electronic versions.

A job queue 512 is suitably in data communication with the print function 504, facsimile function 506, and scan function 508. It will be appreciated that various image forms, such as bit map, page description language or vector format, and the like, are suitably relayed from the scan function 308 for subsequent handling via the job queue 512.

The job queue 512 is also in data communication with network services 514. In a preferred embodiment, job control, status data, or electronic document data is exchanged between the job queue 512 and the network services 514. Thus, suitable interface is provided for network based access to the controller function 500 via client side network services 520, which is any suitable thin or thick client. In the preferred embodiment, the web services access is suitably accomplished via a hypertext transfer protocol, file transfer protocol, uniform data diagram protocol, or any other suitable exchange mechanism. The network services 514 also advantageously supplies data interchange with client side services 520 for communication via FTP, electronic mail, TELNET, or the like. Thus, the controller function 500 facilitates output or receipt of electronic document and user information via various network access mechanisms.

The job queue 512 is also advantageously placed in data communication with an image processor 516. The image processor 516 is suitably a raster image process, page description language interpreter or any suitable mechanism for interchange of an electronic document to a format better suited for interchange with device functions such as print 504, facsimile 506 or scan 508.

Finally, the job queue 512 is in data communication with a parser 518, which parser suitably functions to receive print job language files from an external device, such as client device services 522. The client device services 522 suitably include printing, facsimile transmission, or other suitable input of an electronic document for which handling by the controller function 500 is advantageous. The parser 518 functions to interpret a received electronic document file and relay it to the job queue 512 for handling in connection with the afore-described functionality and components.

Turning now to FIG. 6, illustrated is a representative architecture of a suitable server 600 (depicted in FIG. 1 as the server 122), on which operations of the subject system are completed. Included is a processor 602, suitably comprised of a central processor unit. However, it will be appreciated that processor 602 may advantageously be composed of multiple processors working in concert with one another as will be appreciated by one of ordinary skill in the art. Also included is a non-volatile or read only memory 604 which is advantageously used for static or fixed data or instructions, such as BIOS functions, system functions, system configuration, and other routines or data used for operation of the server 600.

Also included in the server 600 is random access memory 606, suitably formed of dynamic random access memory, static random access memory, or any other suitable, addressable memory system. Random access memory provides a storage area for data instructions associated with applications and data handling accomplished by the processor 602.

A storage interface 608 suitably provides a mechanism for volatile, bulk or long term storage of data associated with the server 600. The storage interface 608 suitably uses bulk storage, such as any suitable addressable or serial storage, such as a disk, optical, tape drive and the like as shown as 616, as well as any suitable storage medium as will be appreciated by one of ordinary skill in the art.

A network interface subsystem 610 suitably routes input and output from an associated network allowing the server 600 to communicate to other devices. The network interface subsystem 610 suitably interfaces with one or more connections with external devices to the server 600. By way of example, illustrated is at least one network interface card 614 for data communication with fixed or wired networks, such as Ethernet, token ring, and the like, and a wireless interface 618, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 614 is interconnected for data interchange via a physical network 620, suitably comprised of a local area network, wide area network, or a combination thereof.

Data communication between the processor 602, read only memory 604, random access memory 606, storage interface 608 and the network subsystem 610 is suitably accomplished via a bus data transfer mechanism, such as illustrated by bus 612.

Suitable executable instructions on the server 600 facilitate communication with a plurality of external devices, such as workstations, document processing devices, other servers, or the like. While, in operation, a typical server operates autonomously, it is to be appreciated that direct control by a local user is sometimes desirable, and is suitably accomplished via an optional input/output interface 622 as will be appreciated by one of ordinary skill in the art.

Turning now to FIG. 7, illustrated is a hardware diagram of a suitable workstation 700, representative of the client devices 128, 130, and 132 of FIG. 1, for use in connection with the subject system. A suitable workstation includes a processor unit 702 which is advantageously placed in data communication with read only memory 704, suitably non-volatile read only memory, volatile read only memory or a combination thereof, random access memory 706, display interface 708, storage interface 710, and network interface 712. In a preferred embodiment, interface to the foregoing modules is suitably accomplished via a bus 714.

The read only memory 704 suitably includes firmware, such as static data or fixed instructions, such as BIOS, system functions, configuration data, and other routines used for operation of the workstation 700 via CPU 702.

The random access memory 706 provides a storage area for data and instructions associated with applications and data handling accomplished by the processor 702.

The display interface 708 receives data or instructions from other components on the bus 714, which data is specific to generating a display to facilitate a user interface. The display interface 708 suitably provides output to a display terminal 728, suitably a video display device such as a monitor, LCD, plasma, or any other suitable visual output device as will be appreciated by one of ordinary skill in the art.

The storage interface 710 suitably provides a mechanism for non-volatile, bulk or long term storage of data or instructions in the workstation 700. The storage interface 710 suitably uses a storage mechanism, such as storage 718, suitably comprised of a disk, tape, CD, DVD, or other relatively higher capacity addressable or serial storage medium.

The network interface 712 suitably communicates to at least one other network interface, shown as network interface 720, such as a network interface card, and wireless network interface 730, such as a WiFi wireless network card. It will be appreciated that by one of ordinary skill in the art that a suitable network interface is comprised of both physical and protocol layers and is suitably any wired system, such as Ethernet, token ring, or any other wide area or local area network communication system, or wireless system, such as WiFi, WiMax, or any other suitable wireless network system, as will be appreciated by one of ordinary skill in the art. In the illustration, the network interface 720 is interconnected for data interchange via a physical network 732, suitably comprised of a local area network, wide area network, or a combination thereof.

An input/output interface 716 in data communication with the bus 714 is suitably connected with an input device 722, such as a keyboard or the like. The input/output interface 716 also suitably provides data output to a peripheral interface 724, such as a USB, universal serial bus output, SCSI, Firewire (IEEE 1394) output, or any other interface as may be appropriate for a selected application. Finally, the input/output interface 716 is suitably in data communication with a pointing device interface 726 for connection with devices, such as a mouse, light pen, touch screen, or the like.

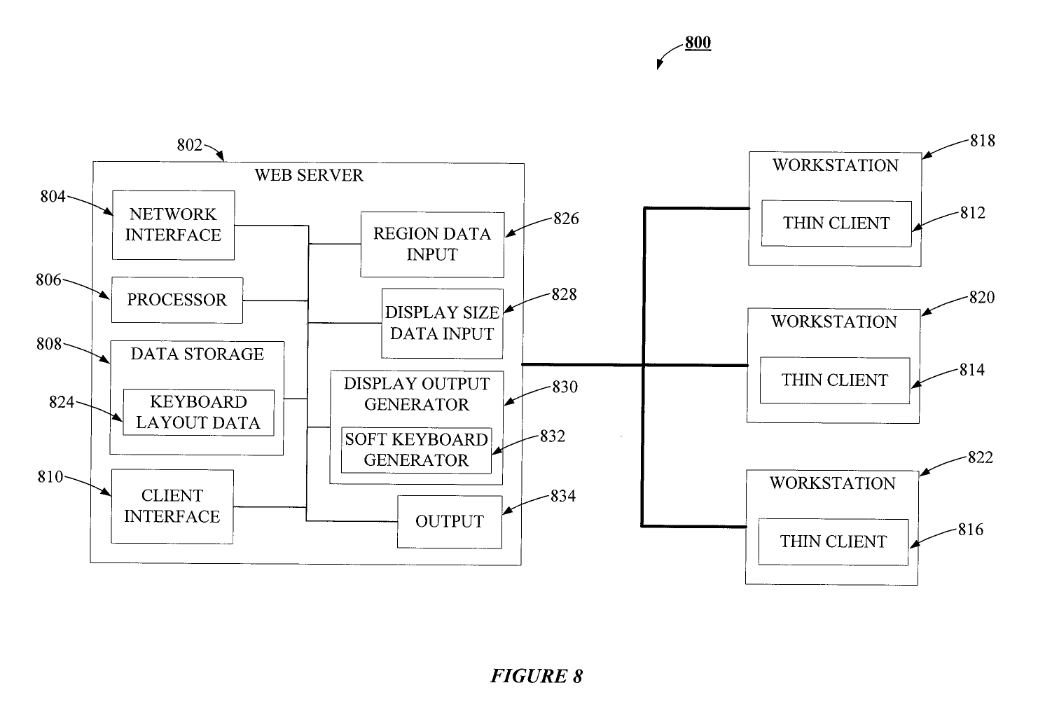

Referring now to FIG. 8, illustrated is a block diagram of a system 800 for web-based soft keyboard character entry in accordance with one embodiment of the subject application. As shown in FIG. 8, the system 800 includes a web server 802 having a network interface 804, a processor 806, and a data storage 808. The web server 802 further includes a client interface 810 configured to establish web connection sessions with each thin client 812, 814, and 816. Each thin client 812, 814, and 816 is preferably disposed on a corresponding workstation 818, 820, and 822 via network connection.

The data storage 808 of the web server 802 typically includes keyboard layout data 824 corresponding to each property of a soft keyboard layout. The web server 802 further includes a region data input 826 configured to receive region data from each of the thin clients 812, 814, and 816 corresponding to the region associated with the respective thin client 812, 814, and 816. The web server 802 also includes a display size data input 828 operable to receive, from each of the thin clients 812, 814, and 816, display size data corresponding to a display size associated with the respective client 812, 814, and 816. Also contained in the web server 802 is a display output generator 830 including a soft keyboard generator 832 operable to calculate target-specific keyboard layout data for each the thin clients 812, 814, and 816 in accordance with the keyboard layout data 824, region data received via the input 826, and display size data received via the input 828 associated with each of the thin clients 812, 814, and 816. The web server 802 further includes an output 834 configured to communicate target-specific keyboard layout data to each thin client 812, 814, and 816 in accordance with an output of the display output generator 830 corresponding thereto so as generate a soft keyboard layout on the thin client 812, 814, and 816.

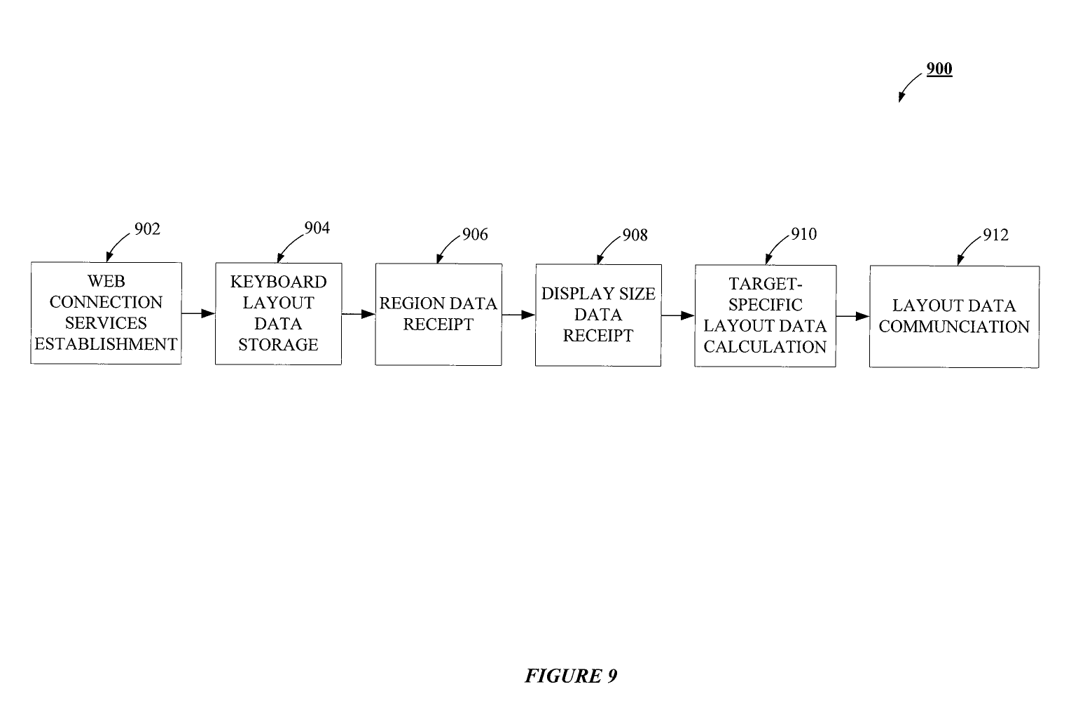

Turning now to FIG. 9, illustrated is a functional diagram of a system 900 for web-based soft keyboard character entry in accordance with one embodiment of the subject application. As shown in FIG. 9, web connection sessions establishment 902 is first performed with each thin client disposed on one of a corresponding number of associated workstations via a network connection. Keyboard layout data storage 904 then occurs of layout data corresponding to each of a number of properties of properties of soft keyboard layout in an associated storage. Region data receipt 906 is then performed of region data corresponding to a region associated with each of the thin clients.

Display size data receipt 908 then occurs from each of the thin clients, which data corresponds to a display size associated with each thin client. Target-specific layout data calculation 910 is then performed of target-specific keyboard layout data for each of the thin clients based upon its associated keyboard layout data, region data, and display size data. Layout data communication 912 then occurs of the calculated target-specific keyboard layout data to each thin client so as generate a soft keyboard layout on the thin client.

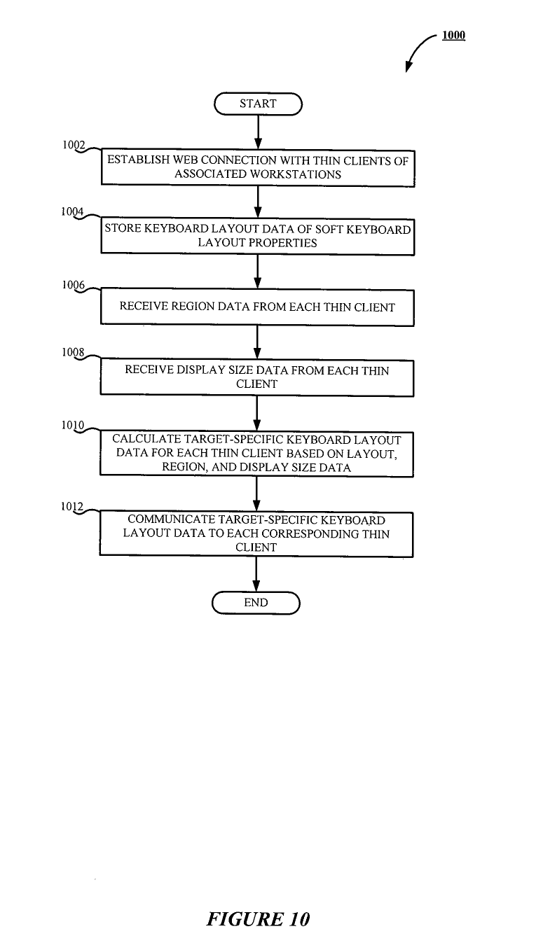

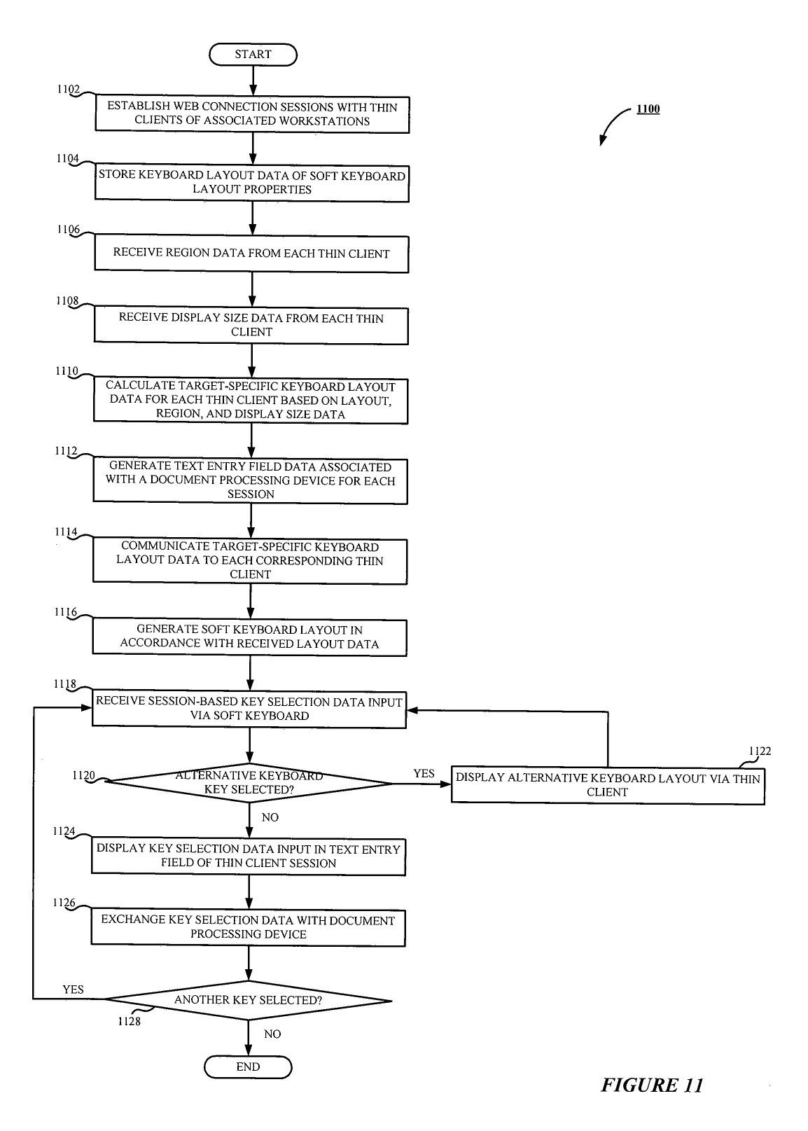

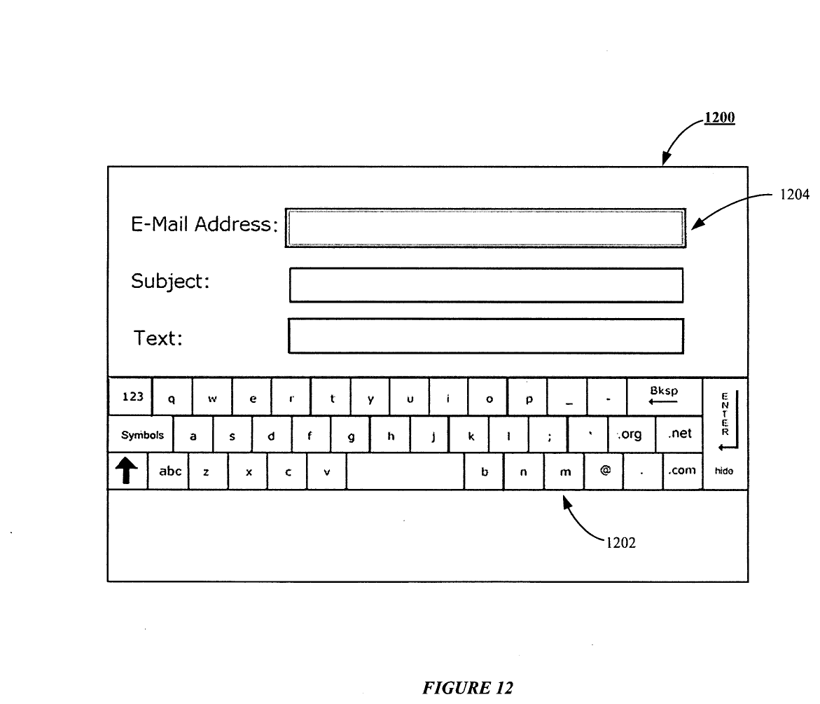

The skilled artisan will appreciate that the subject system 100 and components described above with respect to FIG. 1, FIG. 2, FIG. 3, FIG. 4, FIG. 5, FIG. 6, FIG. 7, FIG. 8, and FIG. 9 will be better understood in conjunction with the methodologies described hereinafter with respect to FIG. 10 and FIG. 11, as well as the example soft keyboard illustration of FIG. 12. Turning now to FIG. 10, there is shown a flowchart 1000 illustrating a method for web-based soft keyboard character entry in accordance with one embodiment of the subject application. Beginning at step 1002, web connection sessions are established with each of a plurality of thin clients, with each thin client being disposed on one of a corresponding plurality of associated workstations via a network connection. Keyboard layout data is stored on an associated storage corresponding to each of a plurality of properties of soft keyboard layout at step 1004.

At step 1006, region data is received from each of the thin clients corresponding to a region associated with the respective client. In accordance with one embodiment of the subject application, the region data represents the region in which the device associated with the thin client is located, e.g. country, state, province, county, city, regional location (Midwest, East, West, North, South, etc) or the like. Display size data is then received at step 1008 from each of the clients corresponding to its respective display size. Target-specific keyboard layout data is then calculated for each of the thin clients at step 1010. Preferably, the target-specific keyboard layout data is calculated from the keyboard layout data, the region data, and the display size data associated with each thin client. Thereafter, at step 1012, the target-specific keyboard layout data is communicated to each corresponding thin client according to the calculation performed at step 1010 so as to enable the generation of a soft keyboard layout on the thin client.

Referring now to FIG. 11, there is depicted a flowchart 1100 illustrating a method for web-based soft keyboard character entry in accordance with one example embodiment of the subject application. The methodology of FIG. 11 begins at step 1102, whereupon web connection sessions are established between the web server 122 and each of a plurality of client workstations or devices, e.g. the workstation 128, the laptop computer 130, and the portable communications device 132. It will be appreciated by those skilled in the art that the controller 108 or other suitable component associated with the document processing device 102 is also capable of establishing a web connection session with the web server 122. Preferably, each client device 128, 130, and 132 include a thin client operative thereon configured to communicate with the web server 122 via the established web connection session. Those skilled in the art will appreciate that suitable thin clients include, for example and without limitation, a web browser, a dedicated interface application, or any other suitable hardware, software, or combination thereof capable of facilitating the operation of a thin client interface.

At step 1104, keyboard layout data is stored in the data storage 124 associated with the web server 122 corresponding to each of a plurality of properties of a soft keyboard layout. Suitable such properties include, for example and without limitation, language set, character set, key size, number of keyboard rows, number of keys, font size, font type, foreground color, background color, and the like. Region data is then received by the web server 122 from each of the thin clients operating on the client devices 128, 130, and 132 at step 1106. Preferably, the region data corresponds to the region in which the device 128, 130, or 132 is located, e.g. country, state, province, county, city, regional location (Midwest, East, West, North, South, etc) or the like. The skilled artisan will appreciate that different regions are capable of having different languages, vernaculars, character sets, or the like, thereby enabling a keyboard to be specified in accordance therewith.

At step 1108, display size data is received from each of the thin clients by the web server 122 corresponding to the size of the display of the associated client device 128, 130, or 132, the user interface 106 or display 114 of the document processing device 104, or the like. The web server 122 then calculates, at step 1110, target-specific keyboard layout data for each of the thin clients in accordance with the keyboard layout data, region data and display size data. Thus, a soft keyboard layout is calculated specifically for the user interface 106, specifically for the display 116, specifically for the workstation 128, specifically for the laptop 130, specifically for the portable communications device 132, and specifically for any other suitable client device having a thin client in data communication with the web server 122 via the computer network 102.

At least one text entry field is then generated by the web server 122 associated with the document processing device 104 for each web connection session at step 1112. At step 1114, the target-specific keyboard layout data, inclusive of any generated text entry fields, is communicated from the web server 122 to each thin client on its respective client device 128, 130, and 132, user interface 106, or display 116 in accordance with the calculations performed at step 1110 and text entry field generated at step 1112. In accordance with one embodiment of the subject application, the target-specific keyboard layout data is capable of implementation as, for example and without limitation, hypertext markup language, JavaScript, or the like. It will be appreciated by those skilled in the art that suitable keyboard layout data includes, for example and without limitation, language, character set, key size, number of keyboard rows, number of keys, keyboard indicia, keyboard color (foreground or background), font type, and the like. The skilled artisan will further appreciate that other layout data is also capable of being used in accordance with the subject application including, for example and without limitation, specific user-based settings, administrator-based settings, customer-based settings, manufacturer-based settings, and the like.

The thin client associated with each client device 128, 130, 132, the user interface 106, or the display 116 facilitates the generation of a soft keyboard layout in accordance with the received keyboard layout data specific to each respective device 106, 116, 128, 130, and 132 at step 1116. FIG. 12 illustrates a template screen 1200 illustrating a soft keyboard 1202 generated in accordance with the system and method of the subject application. The soft keyboard 1202 includes a plurality of keys in designated rows, as well as at least one text entry field 1204 for receipt of user-supplied text. The skilled artisan will appreciate that such text is capable of being received via tactile input by the user via a suitable touch screen associated with the client devices 128, 130, or 132, associated with the user interface 106 or display 116 of the document processing device 104, or the like.

Returning to FIG. 11, session-based key selection data input is then received at step 1118, via the soft keyboard 1202 by the web server 122. According to one embodiment of the subject application, the selection data input corresponds to selections made to the soft keyboard 1202, i.e. selection of a key displayed thereon. At step 1120, a determination is made by the web server 122, the thin client, or the like, whether an alternative keyboard key has been selected. That is, whether the user has selected a key to indicate the keyboard be changed from a standard (QWERTY) keyboard to a nonstandard keyboard (ABCDE) to a numeric keyboard (12345) to a symbolic keyboard (!@#$ % ̂) and or any such switching desired by the associated user. Upon a positive determination at step 1120, flow progresses to step 1122, whereupon the alternative keyboard layout is displayed via the thin client of the corresponding client device 128, 130, 132, user interface 106, or display 116. Operations then return to step 1118 for receipt of session-based selection data input via the soft keyboard 1202.

Upon a determination at step 1120 that an alternative keyboard key has not been selected via the selection input received from the user, flow proceeds to step 1124. At step 1124, the key selection data input in the text entry field is displayed via the thin client of the corresponding client device 128, 130, 132, the user interface 106, or the display 116. The key selection data is then exchanged between the client device 128, 130, 132, the user interface 106, or the display 116, and the document processing device 104 at step 1126. For example, the key selection data is capable of corresponding to a desired document processing operation, a character in an electronic mail address, a number in a facsimile address, or the like. A determination is then made at step 1128 whether another key has been selected by the associated user via the soft keyboard associated with the thin client of the client device 128, 130, 132, the user interface 106, or the display 116. When another key selection has been made, operations return to step 1118 for receipt of the session-based key selection data input via the soft keyboard 1202. When it is determined at step 1128 that no additional keys have been selected, operations with respect to FIG. 11 terminate.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A web-based soft keyboard character entry system comprising a web server having a network interface, a processor and data storage, the web server including:
a client interface operable to establish web connection sessions with each of a plurality of thin clients, wherein each thin client is disposed on one of a corresponding plurality of associated workstations via network connection;
the data storage including keyboard layout data corresponding to each of a plurality of properties of soft keyboard layout;
a region data input operable to receive, from each of the thin clients, region data corresponding to a region associated therewith;
a display size data input operable to receive, from each of the thin clients, display size data corresponding to a display size associated therewith;
a display output generator including a soft keyboard generator operable to calculate target-specific keyboard layout data for each of the plurality of thin clients in accordance with the keyboard layout data, region data and display size data associated with each of the thin clients; and
an output operable to communicate target-specific keyboard layout data to each thin client in accordance with an output of the display output generator corresponding thereto so as generate a soft keyboard layout thereon.

2. The system of claim 1 wherein the target-specific keyboard layout data is comprised of at least one of hypertext markup language and JavaScript.

3. The system of claim 1 wherein the web server further includes:
a text entry field generator operable to generate data corresponding to at least one text entry field operatively associated with a document processing device for each of a plurality of sessions;
a text field input operable to receive session-based key selection data input corresponding to selections made to a soft keyboard layout;
a text output generator operable to display key selection data input in an associated text entry field of a thin client session corresponding thereto; and
an interface operable to exchange the key selection data with the associated document processing device including at least one of a scanner, facsimile machine, printer, e-mail system, and facsimile system.

4. The system of claim 3 wherein the keyboard layout data includes data corresponding to at least one of language, character set, key size, number of keyboard rows, number of keys, keyboard indicia, and keyboard color.

5. The system of claim 4 wherein at least one key of each soft keyboard includes a alternative keyboard function corresponding to a display of an alternative soft keyboard, and wherein the display output generator is further operable to output an alternative keyboard layout to a thin client in a session in connection with a communication session from which a selection of the alternative keyboard function key is received therefrom.

6. A web-based soft keyboard character entry method via a web server having a network interface, a processor and data storage, comprising the steps of:
establishing web connection sessions with each of a plurality of thin clients, wherein each thin client is disposed one of a corresponding plurality of associated workstations via network connection;
storing keyboard layout data corresponding to each of a plurality of properties of soft keyboard layout in an associated storage;
receiving, from each of the thin clients, region data corresponding to a region associated therewith;
receiving, from each of the thin clients, display size data corresponding to a display size associated therewith;
calculating target-specific keyboard layout data for each of the plurality of thin clients in accordance with the keyboard layout data, region data and display size data associated with each of the thin clients; and
communicating target-specific keyboard layout data to each thin client in accordance with the calculation corresponding thereto so as generate a soft keyboard layout thereon.

7. The method of claim 6 wherein the target-specific keyboard layout data is comprised of at least one of hypertext markup language and JavaScript.

8. The method of claim 6 further comprising the steps of:
generating data corresponding to at least one text entry field operatively associated with a document processing device for each a plurality of sessions;
receiving session-based key selection data input corresponding to selections made to a soft keyboard layout;
displaying key selection data input in an associated text entry field of a thin client session corresponding thereto; and
exchanging the key selection data with the associated document processing device including at least one of a scanner, facsimile machine, printer, e-mail system and facsimile system.

9. The method of claim 8 wherein the keyboard layout data includes data corresponding to at least one of language, character set, key size, number of keyboard rows, number of keys, keyboard indicia and keyboard color.

10. The method of claim 9 wherein at least one key of each soft keyboard includes a alternative keyboard function corresponding to a display of an alternative soft keyboard, and displaying an alternative keyboard layout to a thin client in a session in connection with a communication session from which a selection of the alternative keyboard function key received therefrom.

11. A web-based soft keyboard character entry system comprising a web server having a network interface, a processor and data storage, the web server including:
means adapted for establishing web connection sessions with each of a plurality of thin clients, wherein each thin client is disposed one of a corresponding plurality of associated workstations via network connection;
data storage means adapted for storing keyboard layout data corresponding to each of a plurality of properties of soft keyboard layout;
means adapted for receiving, from each of the thin clients, region data corresponding to a region associated therewith;
means adapted for receiving, from each of the thin clients, display size data corresponding to a display size associated therewith;
a display generator, the display generator including means adapted to calculate target-specific keyboard layout data for each of the plurality of thin clients in accordance with the keyboard layout data, region data and display size data associated with each of the thin clients; and
means adapted for communicating target-specific keyboard layout data to each thin client in accordance with an output of the display output generator corresponding thereto so as generate a soft keyboard layout thereon.

12. The system of claim 11 wherein the target-specific keyboard layout data is comprised of at least one of hypertext markup language and JavaScript.

13. The system of claim 11 wherein the web server further includes:
text entry field generator means adapted for generating data corresponding to at least one text entry field operatively associated with a document processing device for each a plurality of sessions;
means adapted for receiving session-based key selection data input corresponding to selections made to a soft keyboard layout;
an output operable to display key selection data input in an associated text entry field of a thin client session corresponding thereto; and
an interface operable to exchange the key selection data with the associated document processing device including at least one of a scanner, facsimile machine, printer, e-mail system and facsimile system.

14. The system of claim 13 wherein the keyboard layout data includes data corresponding to at least one of language, character set, key size, number of keyboard rows, number of keys, keyboard indicia and keyboard color.

15. The system of claim 14 wherein at least one key of each soft keyboard includes a alternative keyboard function corresponding to a display of an alternative soft keyboard, and wherein the display output generator includes means for displaying an alternative keyboard layout to a thin client in a session in connection with a communication session from which a selection of the alternative keyboard function key received therefrom.
